(19) United States
(12) Patent Application Publication
(10) Pub. No.: US 2005/0251072 A1
(43) Pub. Date: Nov. 10, 2005

(54) Buccal Cavity Washer

(76) Inventor: Lalit A. Patel, Chino Hills, CA (US)

Correspondence Address: LALIT A. PATEL, 17355 EAST VIEW DRIVE, CHINO HILLS, CA, 91709, US

(21) Appl. No.: 10/709,492

(22) Filed: May 10, 2004

(51) Int. Cl. A61H 9/00; A61H 13/00

(52) U.S. Cl. 601/162; 601/154; 601/155; 601/160

(57) ABSTRACT

This invention introduces a buccal cavity washer, mainly consisting of an assembly of an Enclosure, a Motor, a set of Pipes, and a set of Tanks, to automate the process of rinsing and washing the buccal cavity.

### BACKGROUND OF INVENTION

Buccal cavity in the mouth should be kept clean to prevent bacterial growth. Gargling is a method for flushing out food and other left-outs from the buccal cavity. This method is manual, difficult for children and patients, and unacceptable in certain cultures and settings.

### SUMMARY OF INVENTION

An object of this invention is to introduce a device to automate the process of rinsing and washing the buccal cavity.

### BRIEF DESCRIPTION OF DRAWINGS

FIG. 1 shows how a typical buccal cavity washer is to be positioned inside the mouth. It schematically shows positions of buccal palate (B), tongue (C), teeth (D), washer Enclosure (E), washer Pipe (P), and washer Tank (T).

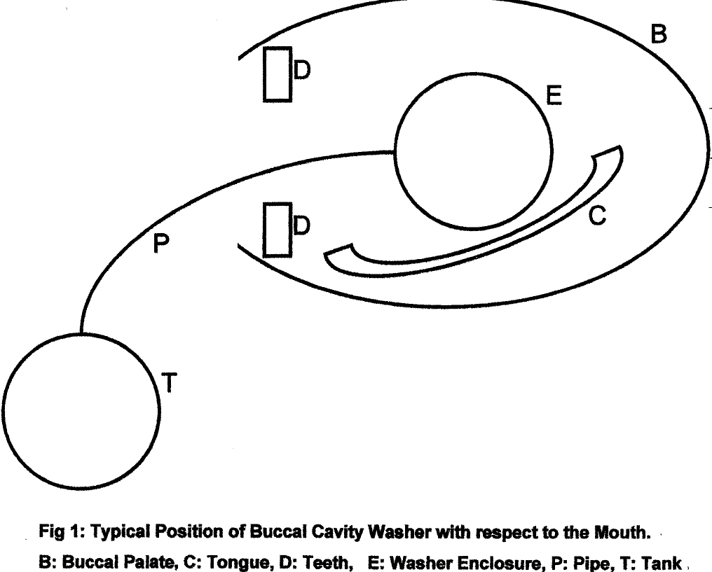

FIG. 2 shows a typical layout of the buccal cavity washer. It shows Enclosure (E), Motor (M), Inflow Pipe (Pi), Outflow Pipe (Po), Input Tank (Ti), and Output Tank (To).

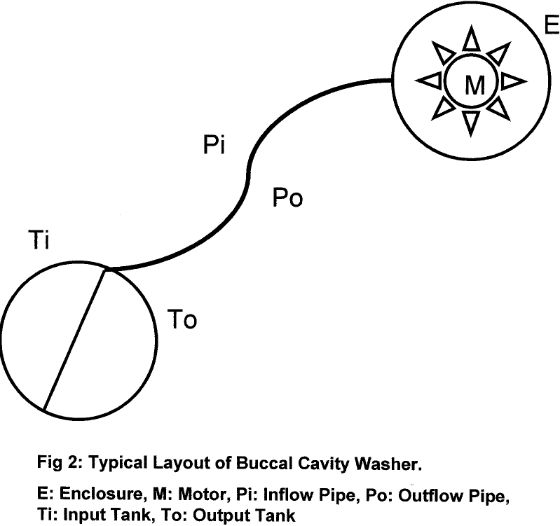

FIG. 3 shows an alternative layout of the buccal cavity washer. The Input Tank (Ti) and Output Tank (To) are adjacent to the Enclosure (E), and Inflow Pipe (Pi) and Outflow Pipe (Po) are embedded within the inter-connected layers of the Enclosure and respective Tanks.

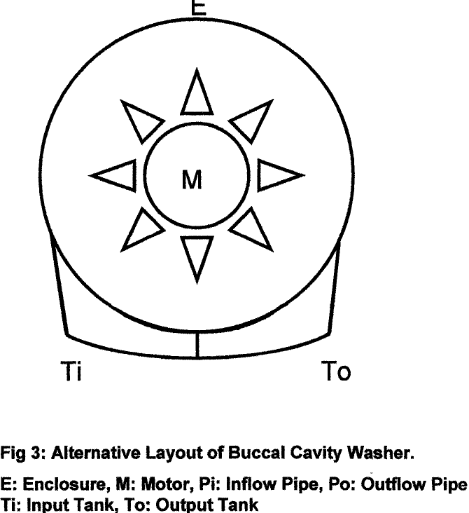

### DETAILED DESCRIPTION

The buccal cavity washer of the present invention mainly consists of an assembly of an Enclosure, a Motor, a set of Pipes, and a set of Tanks.

The Enclosure is basically a semi-permeable cover, which provides a housing for the Motor, and which allows selective bi-directional flow of fluid and particles.

The Motor can be powered electrically, magnetically, mechanically, chemically, by other suitable power source, or by a combination of various power sources. It can vibrate, rotate, and align in multiple directions, as per certain programmable cycles. It functions in such a way that it can pull water or some other fluid from the input Tank and push the fluid into the buccal cavity in an inflow cycle, move the fluid and particles inside the buccal cavity in an interaction cycle, and pull the fluid and particles from the buccal cavity and push them into the output Tank in an outflow cycle.

The inflow Pipe provides a path of flow of fluid from the input Tank to the inside of the Enclosure. The outflow Pipe provides a path of flow of fluid and particles from the inside of the Enclosure to the output Tank.

The input Tank can store fluid to be provided into the buccal cavity. The output Tank can store fluid and particles drained out from the buccal cavity. Both these Tanks are flexible enough to hold varying amounts of contents.

The invention in its preferred embodiment has the input and output Tanks so arranged that they stay outside the mouth, and the Pipes are accordingly long and flexible.

The invention in an alternative embodiment can have the input and/or output Tanks so arranged that they stay inside the mouth, and the Pipes are accordingly short and less flexible.

The invention in another alternative embodiment allows the input Pipe to be connected to a tap fluid from else-where so as to get rid of the input Tank, and/or allows the output Pipe to terminate in an open space so as to get rid of the output Tank.

1. A buccal cavity washer for a buccal cavity, comprising:
an enclosure to allow bidirectional flow of fluid and particles;
a motor to move the fluid and the particles;
an input tank to supply fluid to said motor; and
an output tank to store the fluid and the particles from the buccal cavity;

2. A mechanism to automatically move fluid inside the buccal cavity.

3. A mochanism to automate the process of rinsing and washing the buccal cavity.

4. A buccal cavity washer for a buccal cavity as in claim 1 wherein a first pipe connects the input tank and the motor.

5. A buccal cavity washer for a buccal cavity as in claim 1 wherein a second pipe connects the output tank and the enclosure.
